(19) United States
(12) Patent Application Publication
(10) Pub. No.: US 2010/0175811 A1
(43) Pub. Date: Jul. 15, 2010

(54) INSERT COMPONENT EMBEDDING METHOD

(75) Inventor: Toshio KUMAI, Kawasaki (JP)

Correspondence Address: STAAS & HALSEY LLP, SUITE 700, 1201 NEW YORK AVENUE, N.W., WASHINGTON, DC, 20005, US

(73) Assignee: FUJITSU LIMITED, Kawasaki (JP)

(21) Appl. No.: 12/727,576

(22) Filed: Mar. 19, 2010

Related U.S. Application Data
(63) Continuation of application No. PCT/JP2007/068707, filed on Sep. 26, 2007.

(51) Int. Cl. B32B 7/12

(52) U.S. Cl. 156/91

(57) ABSTRACT

A board comprising a frame comprised of a thermoplastic resin in which an insert part is embedded and metallized over the entire surface by a metal film. In particular, a method of embedding an insert part, while preventing the metal film from being depositing on the female screw in the insert part, a first aspect of which, at first, forming a metal film on the entire surface of the frame including a through hole in the frame, then press fitting the insert part into the through hole. In the second aspect, before the frame in, which the insert part is held, is formed with the metal film, a masking member that covers the entire surface of the female screw of the insert part is attached.

### CROSS-REFERENCE TO RELATED APPLICATION

This application is a continuation application based on International Application No. PCT/JP2007/068707, filed on Sep. 26, 2007, the contents being incorporated herein by reference.

### FIELD

The present embodiments relate to a method for forming a “screw” in a portion of a frame (circuit board) which constitutes a component of an electronic device, more particularly a method for embedding into a portion of a metallized-thermoplastic resin frame an insert-type screw component.

### BACKGROUND

Electronic devices, for example, mobile phones, have a plurality of built-in frames (circuit boards) each with different roles. One example is an electromagnetic shield. This electromagnetic shield conventionally is made from a magnesium alloy, aluminum alloy, titanium alloy, or other light metal alloy to meet conductivity, light weight, and high strength demands.

In this regard, in recent years, other than these demands, there have been additional demands for high thermal conductivity and high optical reflectivity (for example, also functioning as an LCD reflective sheet) and, further, demands for greater design freedom, improved working precision, mass productivity, cost reduction, and the like. To meet these demands, the method of production for the frames by the use of a thermoplastic resin with metal plating (metallizing) has become the general practice.

Frames comprising such thermoplastic resin plates metallized with a metal film are able to realize light weight and high strength to the same extent as the above magnesium alloy frames and can meet the above additional demands as well. An example of such performance, e.g. bending elastic modulus and specific gravity, is described below.

Magnesium alloy (AZ91D)=33 GPa, specific gravity=1.80

PC+ASA-CF10 with Ni plating 60μ/both surfaces=33 GPa, specific gravity=1.60

Incidentally, the PC+ASA-CF10 is available commercially as a high strength cabinet material comprising a thermoplastic resin.

Thus, resin frames have performance superior to light metal alloy frames, but conversely have problems in forming screws. In order to fasten a frame to another circuit part or board, fasten the frame itself to the casing, etc., the frame needs to be provided with a plurality of screws. Such a screw is easily formed in the case of the above alloy, however, in the case of the above resin, threads cannot be directly cut, so a screw must be formed by embedding a metal insert screw part (insert part) into the resin. The screw is formed in advance inside the insert part.

Note that, as known examples relating to the insert part of the embodiments, there are the following Patent Document 1 and Patent Document 2. Patent Document 1 proposes a structure that can prevent the insert part from being pulled out from the frame or the insert part from rotating because of not being firmly fixed to the frame. Further, Patent Document 2 proposes a method of embedding an insert part having as its object to easily and inexpensively embed an insert part into an intermediate layer of a frame without becoming inclined with respect to the surface of the frame.

Patent Document 1: Japanese Patent Publication (A) No. 10-26122

Patent Document 2: Japanese Patent Publication (A) No. 2002-46187

A typical method for embedding an insert part in a metalized frame comprises the steps of:

(1) First placing an insert part inside a mold for forming a frame, then pouring into the mold the resin for forming the frame so as to surround the part and further solidifying it, then

(2) Plating (metallizing) the entire frame, in which the insert part is embedded, with Ni or another metal.

If applying such steps, the metal film from the plating will of course deposit on the surface portion of the internal screw (female screw) of the insert part, in the above step (2). If this happens, at a later step when fastening a male screw into the female screw to fasten to the frame, a printed circuit board, the metal film deposited on the female screw will be scraped off by the male screw thereby creating metal swarf. This swarf will, for example, fall onto the printed circuit board and cause it to short-circuit. Alternatively, if the swarf enters onto a mobile phone LCD screen, it will appear to the user as foreign matter.

Further, there is also the problem that when determining the specifications of the female screw (outside diameter and screw pitch), it is necessary to consider in advance the thickness of the metal film formed on the female screw and variations of the same, thus making selection of the female screw at time of design not that easy.

To solve these problems, there has also been conceived the method of coating the surface of the female screw in the insert part with a resin resist in advance, masking it, then plating the entire surface of the frame with metal. However, with this method, the plating solution temperature (40° C. to 60° C.) will cause voids that are caught in the resist film to thermally expand and burst, the solvent used at time of resist peeling will damage the frame, or the resist will not be able to be clean and safely peeled off.

Generally as a method of precisely masking the hole interior, there is also the method of printing a photosensitive resist, curing it by ultraviolet light, plating, then peeling off the resist with an organic solvent, that is, using so-called photolithography technology, but there is the problem that the cost is high.

### SUMMARY

Accordingly, it is an object of the embodiments, in light of the above problems, to provide a method of embedding an insert part in a frame, capable of fundamentally preventing swarf and capable of making the above-mentioned resist unnecessary even if employing a masking method.

### Technical Solution

According to a first aspect of the invention, there is provided a method of embedding an insert part comprised of a metal in a through hole of a frame which is comprised of a thermoplastic resin and metallized over the entire surface including the inner surface of the through hole by a metal film, comprising (1) a step of heating at least the insert part to a predetermined temperature and (2) a step of press fitting the insert part in the through hole so as to seal the metal film at the inner surface of the through hole together with the softened resin by the heating between the inner surface of the through hole and the outer surface of the insert part. Note that, the through hole may be one in which only the one end at the insert side of the insert part is open while the other end is closed.

Further, according to a second aspect of the invention, there is provided a method of embedding an insert part comprising embedding an insert part comprised of a metal, the inner side of which is formed a female screw, into a frame comprised of a thermoplastic resin, then further metallizing the entire surface with a metal film including (1) a step of fastening the insert part inside the frame, (2) a step of applying a masking member to cover the surface of the female screw at the inside of the fastened insert part, (3) a step of metallizing the entire surface of the frame together with the masking member by a metal film, and (4) a step of removing the masking member after metallization.

According to the first aspect of the invention, the entire frame surface including the through hole is first metal plated, then the insert part heated is press fit into the through hole (so that the metal film deposits on the inner surface), so the metal plating essentially cannot deposit on the female screw of the insert part. Therefore, the above problematic swarf fundamentally cannot occur. This is based on a reversal of the conventional thinking of changing the typical order of steps of “first insert→then plate” to “first plate→then insert”.

However, in the case of these reversed steps, the metal film depositing on the inner surface of the through hole is caught up in and inserted in the thermoplastic resin of the through hole portion, so the above problems will not be solved by lowering the tensile strength and rotational torque force of the frame of this insert part. These tensile strength and rotational torque force were measured by predetermined test devices. The results were high measurement values such as 145N and 40N·cm. By this, it was confirmed that there were absolutely no problems in practice.

Further, according to the second aspect of the invention, it is learned that it is not necessary at all to use a general resist as a conventional masking method. A masking member by itself such as a resin male screw, silicone rubber plug, and the like is sufficient to prevent depositing of metal film on the female screw surface.

### BRIEF DESCRIPTION OF DRAWINGS

FIG. 1 is a view illustrating a method according to a first aspect of the embodiment as steps (A) and (B).

FIG. 2 is a view further specifically illustrating the state until embedding an insert part 2 into a frame 1 with the states (A), (B), (C). and (D).

FIG. 3 is a view illustrating a first example of a defective state of an insert with a cross-sectional view (A) and a bottom view (B).

FIG. 4 is a view illustrating a second example of a defective state of an insert with a cross-sectional view (A) and a bottom view (B).

FIG. 5 is a view illustrating a second different example based on the first aspect of the embodiment with the three states (A), (B), and (C).

FIG. 6 is a view illustrating a second different example based on the first aspect of the embodiment with the three states (A), (B), and (C).

FIG. 7 is a view illustrating another different example.

FIG. 8 is a view for explaining a tensile test on an insert part 2.

FIG. 9 is a view for explaining a rotational torque force of an insert part 2.

FIG. 10 is a view illustrating a method according to a second aspect of the embodiment as steps (A) and (B).

FIG. 11 is a cross-sectional view illustrating a first example based on the second aspect of the embodiment.

FIG. 12 is a cross-sectional view illustrating a second example based on the second aspect of the embodiment.

FIG. 13 is a view illustrating a third example based on the second aspect of the embodiment with the three states (A), (B), and (C).

FIG. 14 is a view illustrating a fourth example based on the second aspect of the embodiment with the three states (A), (B), and (C).

FIG. 15 is a view illustrating a fifth example based on the second aspect of the embodiment with the three states (A), (B), and (C).

FIG. 16 is a view illustrating an example of a frame in which an insert part is embedded.

FIG. 17 is a view illustrating conventional general insert steps (A), (B), and (C).

FIG. 18 is a view illustrating a detailed example of a frame (resin body) in which an insert part is embedded through the steps of FIG. 17 with the three states (A), (B), and (C).

### DESCRIPTION OF THE INVENTION

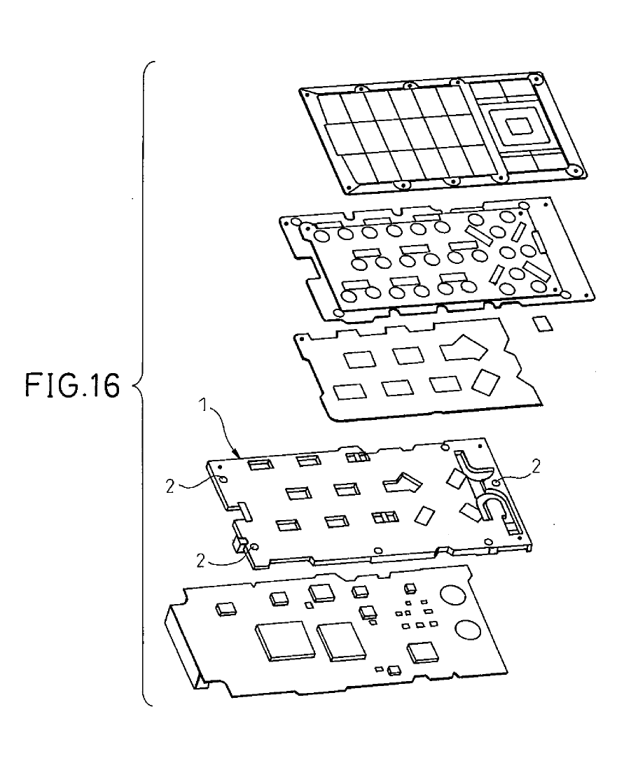

To first simply explain the prior art, FIG. 16 is a view showing an example of frame in which an insert part is embedded and a disassembled perspective view of parts of a mobile phone.

In the drawing, reference number 1 is a frame comprised of a thermoplastic resin having its total surface metallized. In this frame 1, insert parts 2 (three in the drawing) are embedded. The entire assembly functions as an electromagnetic shield.

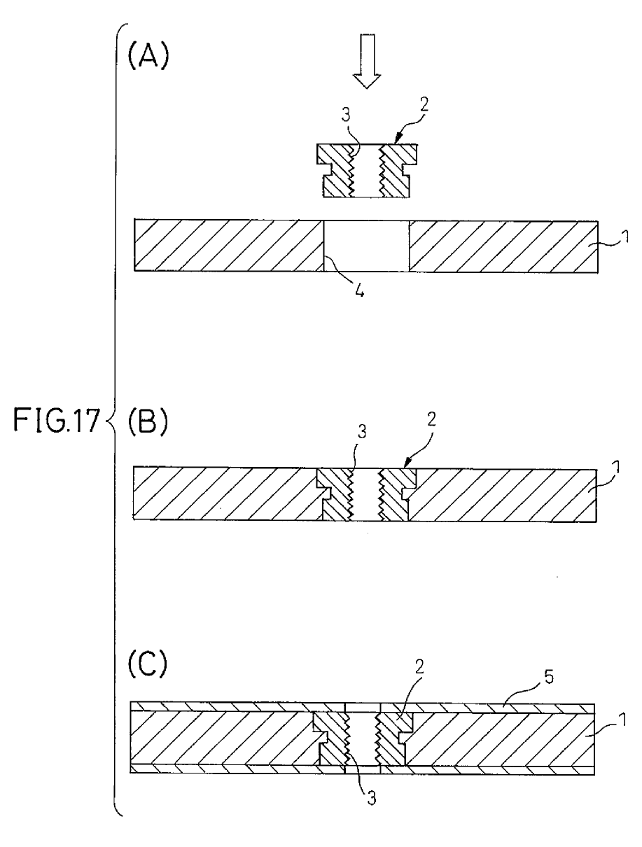

FIG. 17 is a view illustrating the conventional general insert steps (A), (B), and (C). This drawing shows:

a step (A) of positioning a heated insert part 2 toward a through hole 4 of the frame 1,

a step (B) of softening the area around the through hole 4 with the heated insert part 2 while press fitting it into the frame 1, and

a step (C) of metallization for plating the entire surface of the frame 1 in which the insert part 2 is press fit with a metal film 5. At this time, the metal film 5 sticks also on the entire surface of the female screw 3 formed inside the insert part 2. This deposited metal film 5 is the source of the problematic swarf mentioned above.

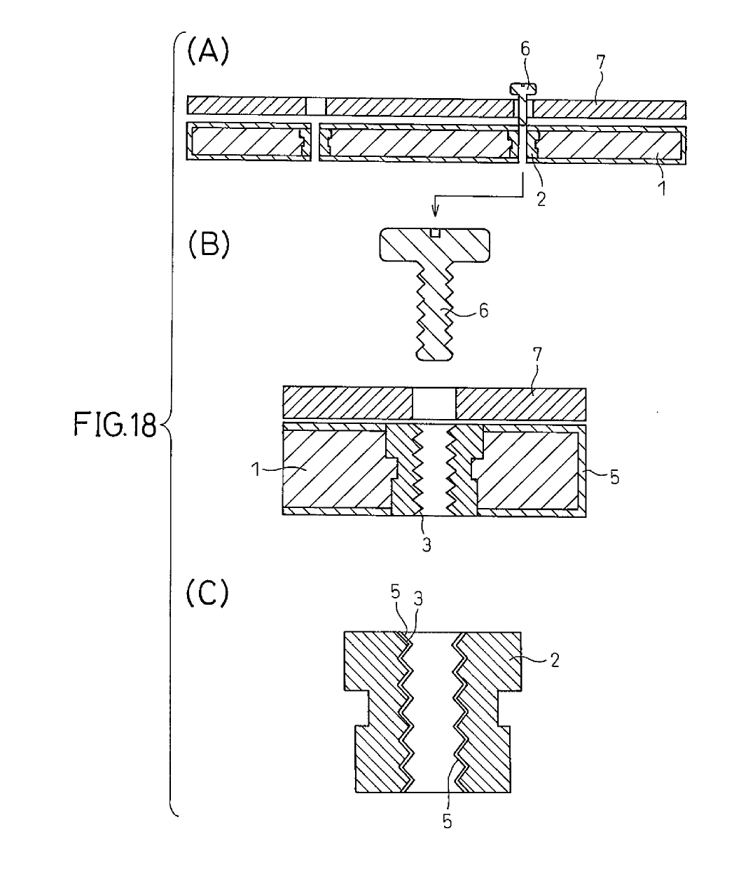

FIG. 18 is a view illustrating a detailed example of a frame in which an insert part is embedded, prepared by the steps of FIG. 17 by three states (A), (B), and (C). In the example of this drawing, the state of using a male screw 6 to fasten another circuit board (or housing case) 7 to the frame 1 along with the female screw 3 of the insert part 2 is illustrated in (A).

(B) of this drawing is an enlarged view of the fastened portion. When fastening the male screw 6 to the female screw 3, the above-mentioned problematic swarf is produced. (C) of the drawing illustrates, slightly enlarged, the metal film (Ni) 5 deposited on the surface of the female screw 3, i.e. the source of the swarf.

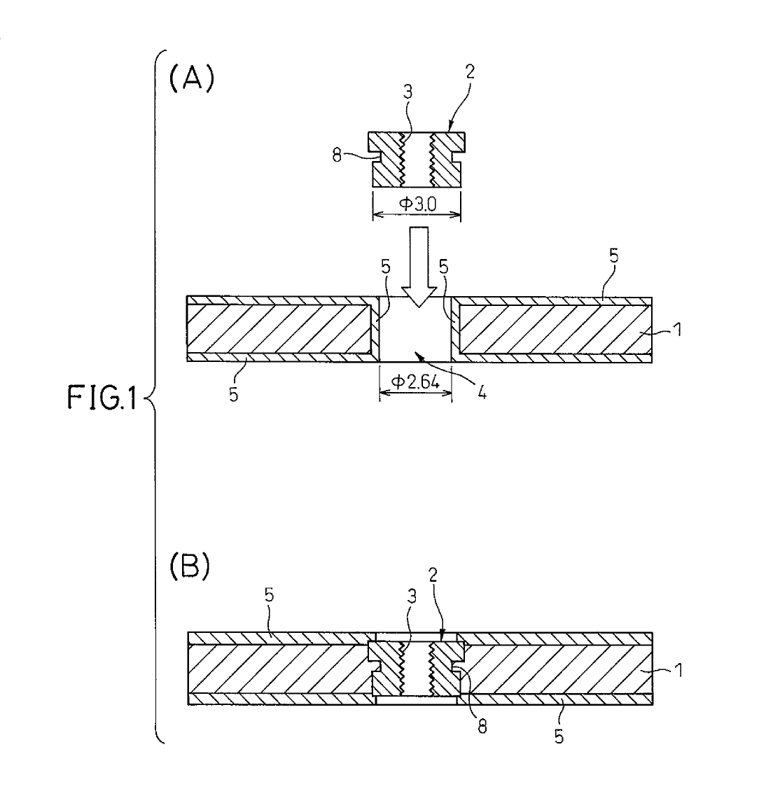

FIG. 1 is a view illustrating a method according to a first aspect of the embodiment as the steps (A) and (B). This drawing shows:

a step (A) of heating at least the insert part 2 to a predetermined temperature (the frame also may be heated together) and

a step (B) of press fitting the insert part 2 into the through hole 4 so as to seal the metal film 5, at the inner surface of the through hole 4, together with the softened resin in the space between the inner surface of the through hole 4 softened by the heating and the outer circumferential surface of the insert part 2. Further details are as follows.

For example, a PC+ASA-CF10 (or ABS, PMMA, PC, PA, polylactic acid, plant resin, etc.) resin frame 1 (thickness of 2 mm) has a through hole 4 (φ2.7) which is formed for inserting an insert part 2 therein. By forming about 3 μm of Cu by electroless plating on the entire surface of the frame 1 and then plating the entire surface with Ni (or Sn, Zn, Au, Ag, Cr, or Hastelloy alloy) by electroless plating to a thickness of 30 μm, a strength equivalent to the Mg alloy is obtained, further a high conductivity is also obtained, and thus the frame 1 can be made to function as, for example, an electromagnetic shield.

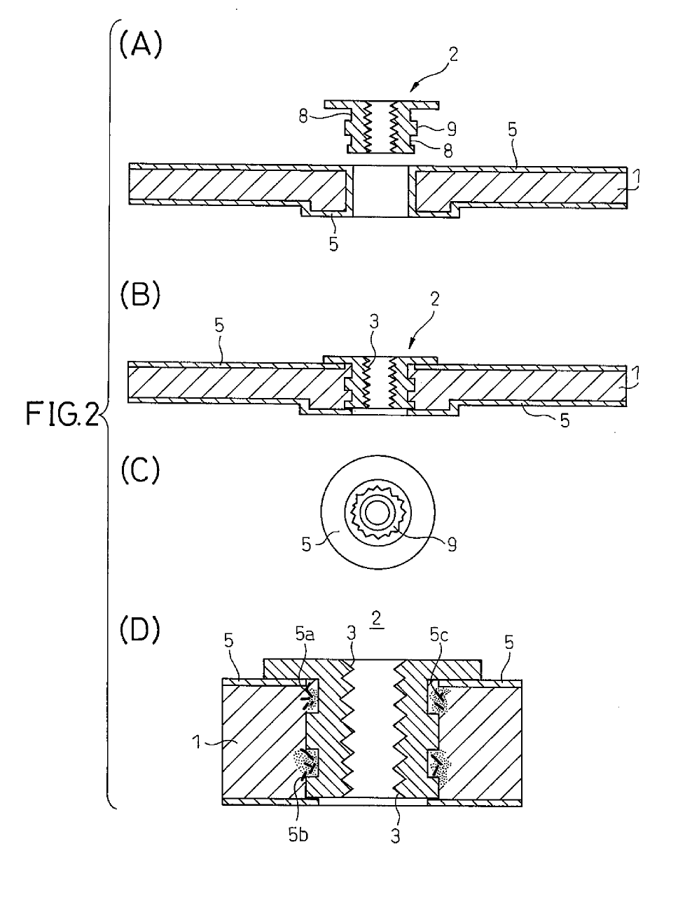

Next, by heating an insert part 2, having an outside diameter of 3.0 mm, to approximately 120° C. and press fitting it in the hot state, the entire resin frame 1 softens, wherein the force of the press fitting finely crushes the Ni plating film and the crushed Ni plating film is pushed into a groove 8 of the insert part 2. That is, in the first aspect of the embodiment, the outer circumferential surface of the insert part 2 has at least one groove 8 (two grooves in FIG. 2) along the circumference. In the grooves 8, the metal film 5 as well as the softened inner surface of the through hole 4 are embedded.

If testing the performance of the entire frame 1 after cooling, a vertical tensile strength of the insert part 2 of about 120 N is obtained and a rotational torque force of about 240 N·cm is obtained. Afterwards, by fastening, for example, a printed circuit board by the screws 3 and 6 (FIG. 18), the strength is reinforced or an electromagnetic shield is obtained.

In this case, high adhesive strength is obtained through the engaging force between the insert part 2 and the frame 1 at the through hole 4. At this time, an appropriate fit is obtained by the balance in terms of the dimensions between these. If the outside diameter of the insert part 2 is too large, the through hole 4 will crack and break.

Further, if the heating temperature of the insert part 2 is low, cracks form. Conversely, if too high, the frame 1 deforms and the excess resin builds up. This buildup often has negative effects on the smooth fit and hinders fastening with other circuit boards 7 cofastened with. Further, if this buildup becomes excessive, resin will flow into the female screw 3 of the insert part 2 and reliable fastening is no longer possible or the reliability is adversely affected. Note that, if the heating temperature of the insert part 2 is set near the Vicat softening point of the resin which forms the frame 1, substantially suitable insertion can be performed.

FIG. 2 is a view further specifically illustrating the state until embedding an insert part 2 into a frame 1 by the states (A), (B), (C), and (D). (A) in the drawing shows, as another example of an insert part 2, an insert part having two grooves 8 and a knurled thread 9.

(B) in the drawing illustrates a state in which the insert part 2 is heated and press fit into the through hole 4 of the frame 1, and (C) in the drawing illustrates a plane view of the insert part 2 of (B) when seen from below.

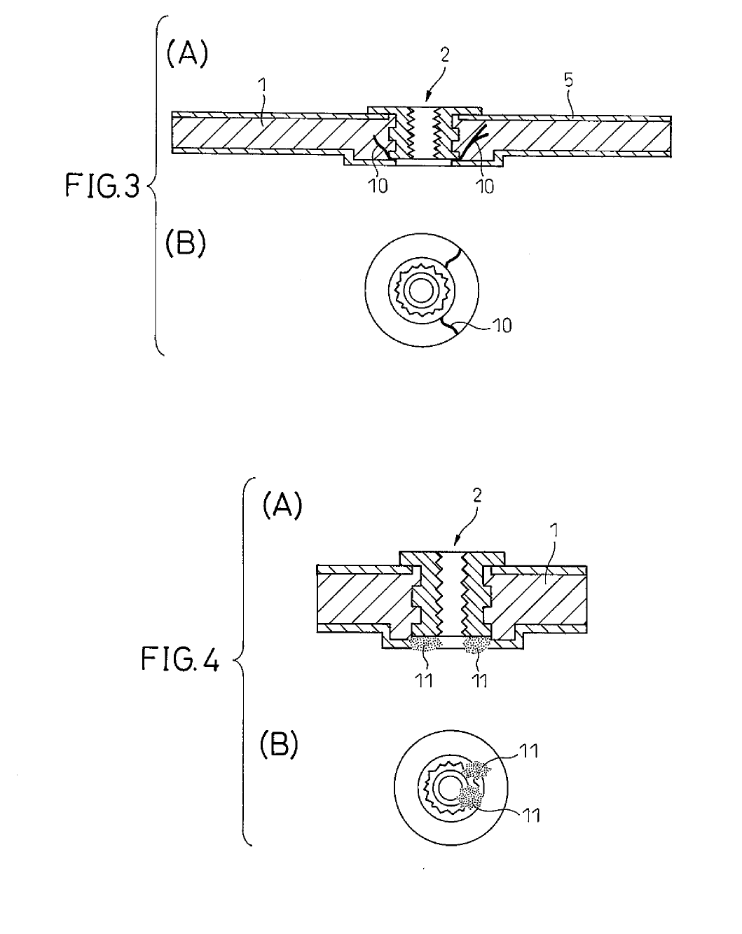

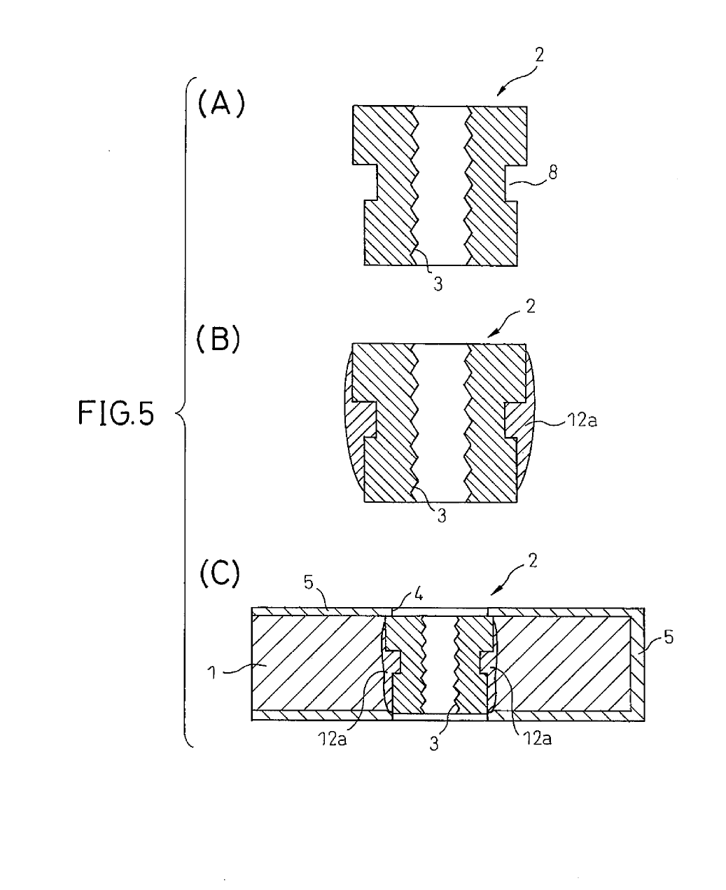

(D) in the drawing is a cross-sectional view illustrating an enlarged view of the insert part 2 embedded in the frame 1 in (B). In (D), 5a shows the state of softened resin (1) flowing into the grooves 8 together with the metal film 5, 5b fragments of the metal film 5, and 5c the crushed portion of the metal film 5. (B) to (D) in the drawing show states where insertion is good. On the other hand, states where the insertion is not good are shown in FIG. 3 and FIG. 4 to be explained later.

The explanation of FIG. 2 may be supplemented as follows. According to the example illustrated in the drawing, the insert part 2 (for example, 178WR13-BZ5A made by ITEC Corporation) has specifications of a material of BS (brass), a female screw 3 of M1.6×0.35, a total length of 2.0 mm, and a diameter of the knurled part 9 of 3.0φ. An insert jig (press fitting bit) heated to approximately 260° C. is made to contact the top of the insert part 2.

If heating the insert part 2 for approximately 3 seconds, thermal conduction will cause the resin frame 1 to begin softening. If applying major insertion pressure (about 0.2 MPa) at such a softening timing, the insert part 2 will smoothly enter the through hole 4 of the resin frame 1, after which insertion ends.

Due to the above press fitting force, the softened frame resin (the resin will not melt) is pushed into the grooves (cavities) 8 of the insert part 2. At the same time, the metal film 5 (approximately 30 μm thick) also breaks and is crushed and is pushed together with the softened resin into the grooves 8.

FIG. 3 is a view showing a first example of a defective insertion state with a cross-sectional view (A) and a bottom view (B). This first example illustrates a state in which cracks 10 form because of insufficient softening of the resin (1), that is, because of insufficient heating at the time of insertion.

FIG. 4 is a view illustrating a second example of a defective insertion state with a cross-sectional view (A) and a bottom view (B). This second example illustrates a state in which the above-mentioned resin buildup 11 forms because of excessive softening of the resin (1), that is, because of the excessive heating temperature and/or excessive press fitting force at time of insertion.

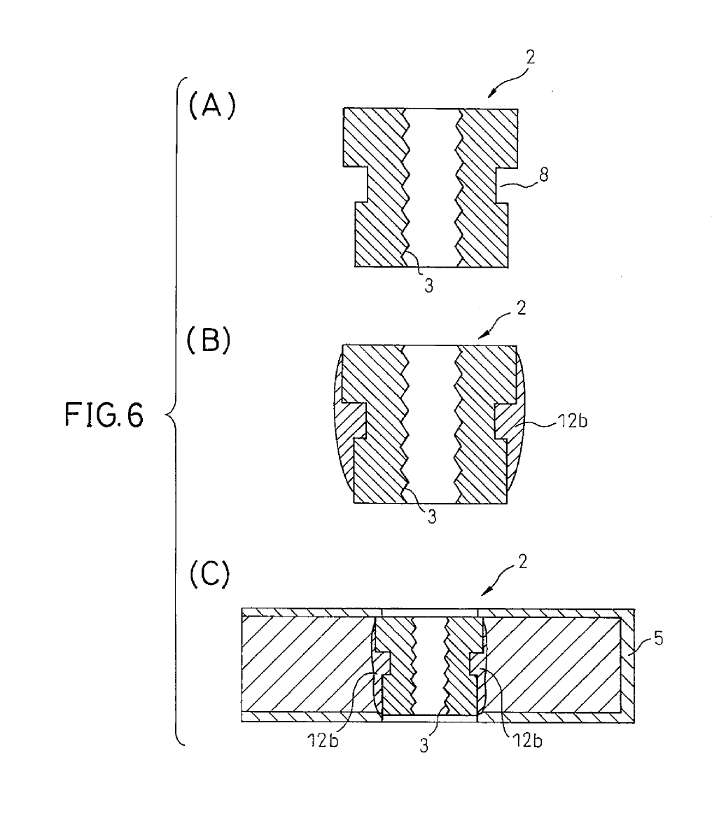

Next, a different example based on the first aspect of the embodiment will be explained. This different example has a further step of forming a resin layer (12) in advance at the outer circumferential surface of the insert part 2. A specific first example (FIG. 5) and second example (FIG. 6) are illustrated below.

FIG. 5 is a view illustrating a first other example based on the first aspect of the embodiment by the three states (A), (B), and (C). In this example, the resin layer (12) is comprised of a curing reaction type resin 12a. As a preferred example, the curing reaction type resin 12a is a rapid curing epoxy resin.

FIG. 5(A) illustrates a cross-sectional view of the insert part by itself, while (B) illustrates a state where the outer circumferential surface of the insert part 2 is coated with a curing reaction type resin (rapid curing epoxy resin) 12a. (C) illustrates a state where this is heated and press fit into the through hole 4 of the frame 1.

Explaining a specific example further, the insert part 2 is coated with a rapid curing epoxy resin (MR-8128N, Panasonic Factory Solutions Co., Ltd.) 12a and the insert part 2 is heated to approximately 120° C. and held there for 10 seconds as “insertion work”. In this case, the frame resin (1) softens and further bonds with the insert part 2. This function is further augmented by the adhesive effect from an adhesive (12a). Therefore, the vertical tensile strength rises to about 150N and the rotational torque force to about 50N·cm. Note that, it is also possible to adopt the step of, after several seconds insertion, baking the frame 1 as a whole at 120° C.×1 minute to cause the rapid curing epoxy resin to completely cure.

FIG. 6 is a view illustrating a second other example based on the first aspect of the embodiment by the three parts (A), (B), and (C). In this example, the above-mentioned resin layer (12) is comprised of a soft resin 12b. As a preferable example, the soft resin 12b is a polyamide resin or a urethane resin.

(A), (B), and (C) in the drawing respectively correspond to (A), (B), and (C) in FIG. 5 above.

If further explaining the specific example, the outer circumferential surface of the insert part 2 is coated with a melted polyamide (PA) resin to about approximately 20 μm thickness (B). If the insert part 2 is inserted into the through hole 4 in this state, because the coated PA resin has appropriate elasticity (PA resin does not melt), the frictional resistance force with the insert side increases, thereby increasing the tensile strength which is an indicator of the resistance of the insert part 2 to detachment after insertion.

If comparing the structures of the above FIG. 1 and FIG. 2, the vertical tensile strength of the insert part 2 rises to about 140N, and the rotational torque force rises to about 50N·cm. Note that, as an alternative to a PA resin, ABS, PS, hard rubber, or other organic substances also demonstrate equivalent functions and effects.

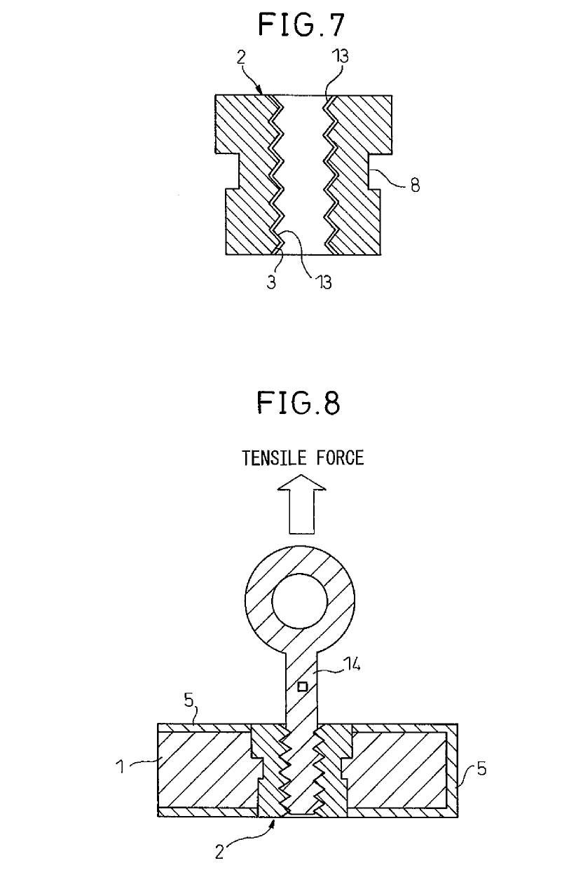

FIG. 7 is a view illustrating another example which further adds a step of forming, in advance, an electroplating layer or a dip-soldered plating layer on the outer circumferential surface of the insert part 2. As a specific example, the outer circumferential surface of the insert part 2 is electroplated or dip-soldered plated with Sn-based Pb-free solder material (for example, Sn—Ag3—Cu 0.5, melting point 217° C.). Even if hot inserting the insert part into the resin frame (1) without melting solder material, the insertion strength can be improved. The reason is that a solder material is soft and the surface is rough, so the frictional resistance of the wall surface of the insert part 2 will increase and the tensile strength and rotational torque force of the insert part 2 will increase.

If supplementarily explaining the metal film 5 used in the first aspect of the embodiment illustrated in FIG. 1 to FIG. 7, we get the following. (Note that the same applies to the metal film 5 in the second aspect of the embodiment mentioned later). The metal film 5 is comprised of any of the following pairs of materials and film thicknesses, that is:

Ni film: film thickness 3 to 100 μm

Sn alloy film: film thickness 3 to 200 μm

Al alloy film: film thickness 3 to 200 μm

Au film: film thickness 3 to 200 μm

Ag alloy film: film thickness 3 to 200 μm

Cr film: film thickness 3 to 100 μm

C film: film thickness 3 to 400 μm

Further, the metal film 5 is formed by any of:

Electroless plating or electrolytic plating or another wet process

Vacuum deposition

Sputtering

Electron beam

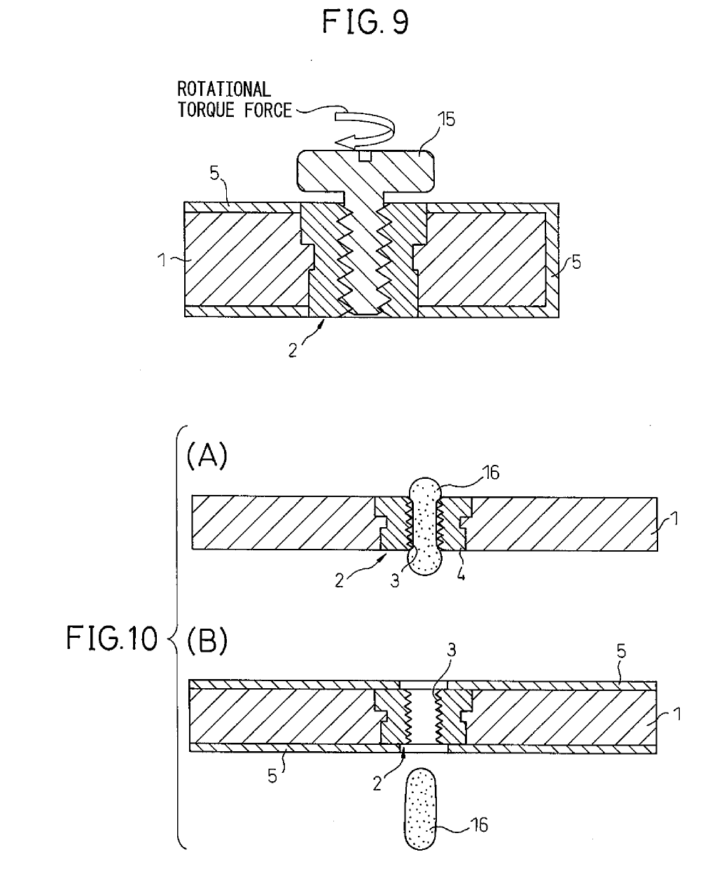

FIG. 8 is a view for explaining a tensile test of the insert part 2, while FIG. 9 is a view for explaining the rotational torque force of the insert part 2.

In FIG. 8, in a finished product having the insert part 2 embedded in the through hole 4 of the frame 1, a tensile test use male screw 14 is engaged with the female screw 3 of the insert part 2. In this state, the tensile test use male screw 14 is pulled up in the arrow direction. Further, the tensile strength (N), when the insert part 2 is detached from the frame 1, is measured.

On the other hand, in FIG. 9, in a similar manner, a rotation test use male screw 15 is rotated in the arrow direction in the drawing. When the rotation force exceeds the joining strength limit of the insert part 2 to the frame 1 and the insert part 2 begins to rotate, the rotational torque force (N·cm) at this time is measured with a torque driver. The results are shown in the following table.

TABLE 1

| Insert | | | Rotational |
|---|---|---|---|
| part | | Tensile | torque force |
| sample | Embedding method | force | (Ncm) |
| A | FIG. 2 | 128 | >40 |
| B | FIG. 5 (PA resin 10 μm) | 135 | >40 |
| C | FIG. 6 (rapid curing adhesive 10 μm) | 140 | >40 |

Next, a second aspect of the embodiment will be explained. FIG. 10 is a view illustrating a method according to a second aspect of the embodiment as steps (A) and (B). This method comprises

a step of, for example, placing an insert part 2 inside a mold and pouring thermoplastic resin so as to fasten the insert part 2 inside the frame 1,

a step of applying a masking member 16 to cover the surface of the female screw 3 at the inner side of the insert part 2 fastened inside the frame 1 (see FIG. 10(A)),

a step of metallizing the entire surface of the frame 1 together with the masking member 16 by the metal film 5, and

a step of removing the masking member 16 after metallization (see FIG. 10(B)).

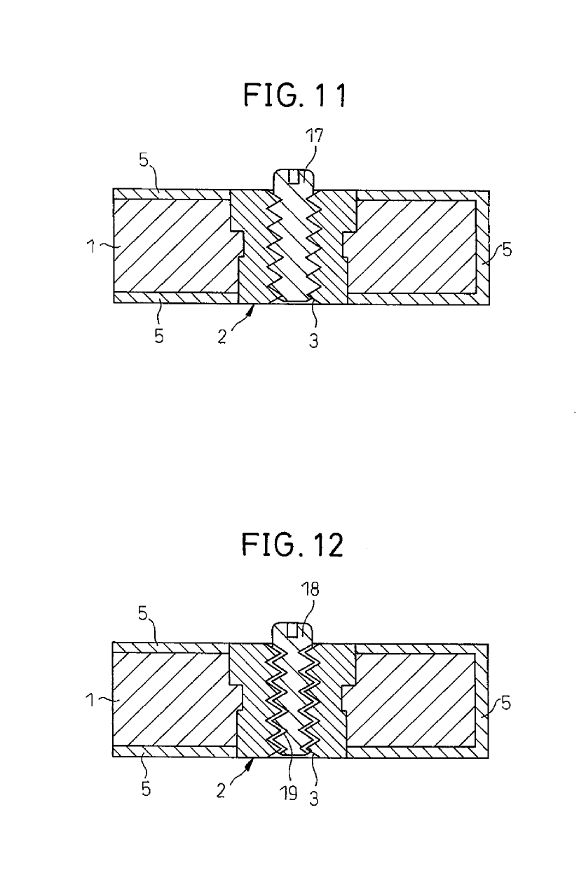

FIG. 11 is a cross-sectional view illustrating a first example based on the second aspect of the embodiment. As shown in the drawing, in this first example, in the above step of applying a masking member 16, the masking member may be comprised of a masking use resin male screw 17 which engages with the female screw 3.

FIG. 12 is a cross-sectional view illustrating a second example based on the second aspect of the embodiment. As shown in the drawing, in this second example, in the above step of applying a masking member 16, the masking member is comprised of a masking use metal male screw 18 which engages with the female screw 3 and the surface of the metal male screw 18 is coated with a resin layer 19.

As this resin layer 19, a polyamide resin, polycarbonate resin, fluorine resin, or silicone-based resin can be used.

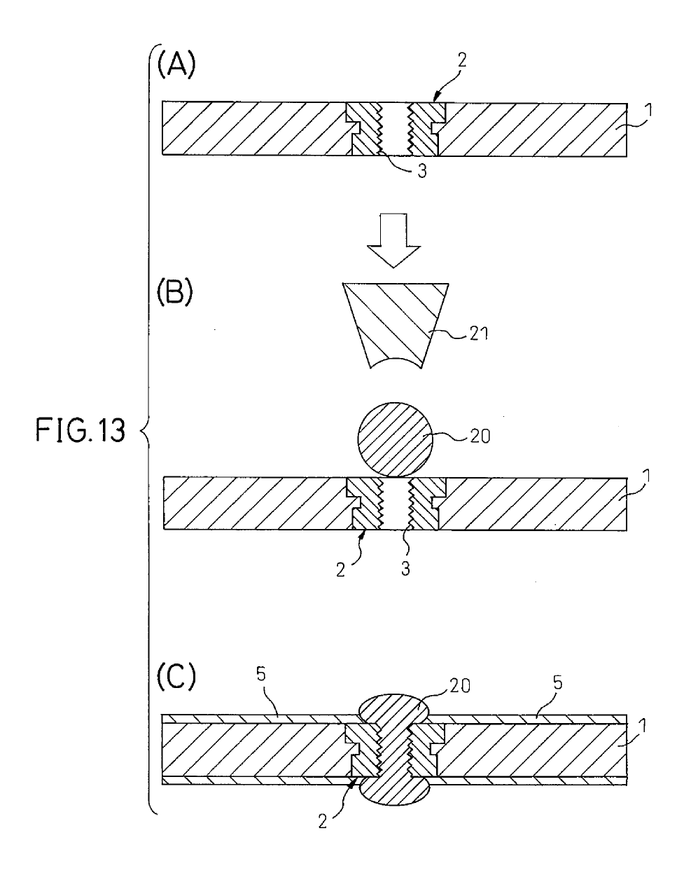

FIG. 13 is a view showing a third example based on the second aspect of the embodiment by the three states (A), (B), and (C). In the drawing, 20 is a soft silicone rubber masking member, and 21 a pushing jig that pushes the member 20 into the female screw 3 of the insert part 2. That is, in the step of applying the masking member 16, the masking member is comprised of the soft silicone rubber 20. The soft silicone rubber 20 is pushed into the female screw 3 with the pushing jig 21. Then, the silicone rubber 20 is removed from the insert part 2.

For example, as shown in the drawing, after press fitting the spherical soft silicone rubber (rubber hardness 20) 20 into the female screw 3 of the insert part 2, then Ni plating (5) is achieved, then removing the soft silicone rubber 20, an insert part 2, in which the metal (Ni) plating film does not deposit on the female screw 3, can be realized. Note that, silicone rubber is superior in flexibility, heat resistance, and chemical resistance and is able to withstand a plating solution temperature of 60° C., so repeated use is possible. Further, as alternatives, an EPDM rubber or fluorine-based rubber may also be used.

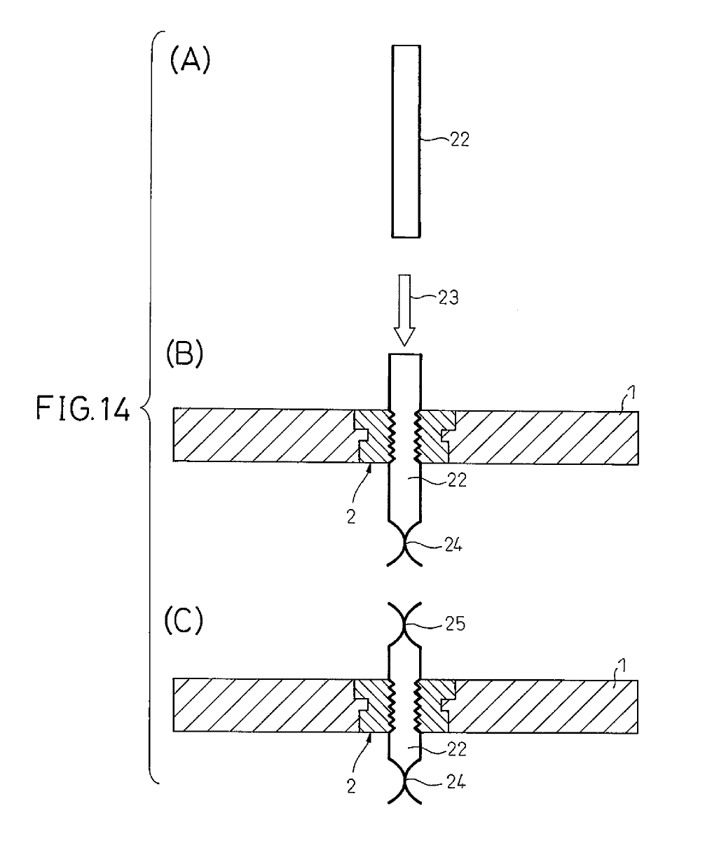

FIG. 14 is a view illustrating a fourth example based on the second aspect of the embodiment by the three states (A), (B), and (C). As shown in the drawing, in this fourth example, in the above step of applying the masking member 16, a resin hollow pipe 22 is inserted into the female screw (3), the hollow pipe 22 is charged with air (air blowing 23), and the two ends are sealed with sealing portions 24 and 25 to thereby make the masking member. After this, this balloon-like hollow pipe 22 is removed from the insert part 2.

For example, a polyethylene tube is inserted into the female screw 3 of the insert part 2, air is blown inside 23, and the tube is made to be adhere to the wall surface of the female screw. Then, this tube is heated and sealed (24, 25) for masking. Next, the plating step is entered. After the end of the plating (5), the hollow tube 22 is pulled out or is punctured and removed by the impact. Note that, the plating solution temperature is approximately 60° C., but a polyethylene tube has heat resistance and, further, has a high chemical resistance, and plating solution does not deposit on it.

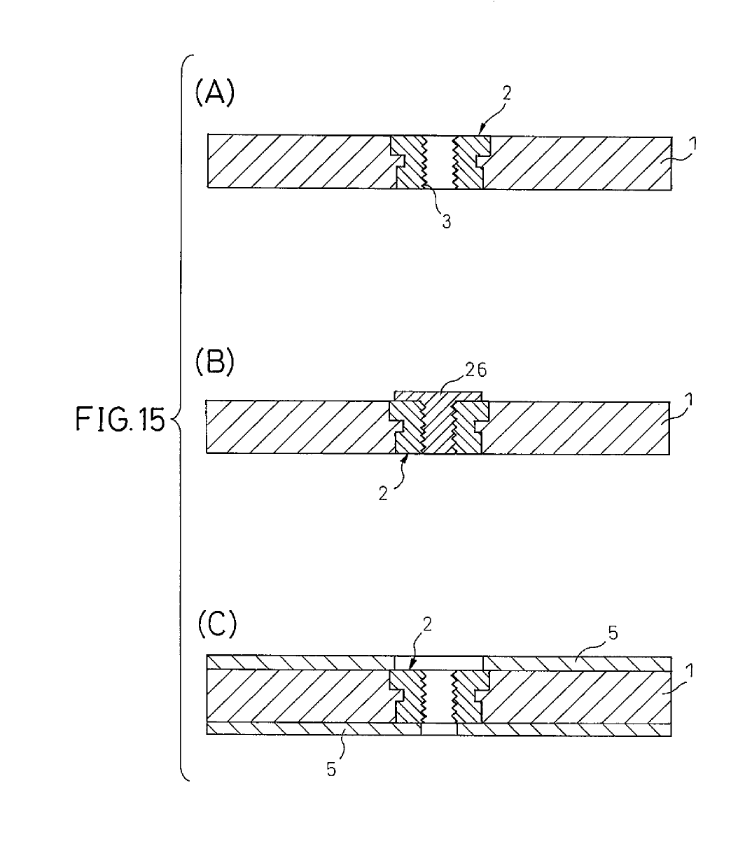

FIG. 15 is a view illustrating a fifth example based on the second aspect of the embodiment by the three states (A), (B), and (C). As shown in this drawing, in this fifth example, in the above step of applying the masking member 16, the masking member is a paste-like printing ink 26 comprised of paraffin screen printed so as to be pushed into the female screw 3.

For example, a polyethylene-based paraffin (melting point approximately 108° C.) is dissolved with alcohol or another high boiling point organic solvent to prepare the paste-like printing ink 26. Next, the printing ink 26 is screen printed. In this case, if placing the inside of the female screw 3 of the insert part 2 in a negative pressure suction state, the female screw 3 can be charged with paraffin even more reliably.

Further, after drying, plating (5) is carried out. After plating formation, the printed paraffin is removed with acetone or another organic solvent. The polyethylene-based paraffin has a melting point of about 108° C. and does not soften at the plating solution temperature of 60° C., so it can endure detachment. Further, if heated to about 120° C., the polyethylene-based paraffin melts into a liquid and can be removed by spraying of air, warm water, steam, etc., so an organic solvent becomes unnecessary. This makes it convenient for environmental measures against volatile organic compounds (VOC).

### EXPLANATION OF REFERENCES

1 frame
2 insert part
3 female screw
4 through hole
5 metal film
6 male screw
7 different circuit board (or housing case)
8 groove
9 knurled thread
12 resin layer
12a curing reaction type resin
12b soft resin
13 plating layer
16 masking member
17 masking male screw
18 masking male screw
19 resin layer
20 masking member (soft silicone rubber)
22 hollow pipe
26 printing ink

1. A method of embedding an insert part comprised of a metal in a through hole of a frame comprised of thermoplastic resin having a through hole and having an entire surface, including the through hole inner surface, metallized with a metal film, said insert part embedding method comprising:
heating at least the insert part to a predetermined temperature; and
press fitting the insert part into the through hole so as to seal the metal film, at the inner surface of the through hole, together with the resin between the inner surface of the through hole softened by the heating and the outer circumferential surface of the insert part.

2. The method of embedding an insert part as set forth in claim 1, wherein the outer circumferential surface of the insert part has at least one groove along the circumference and embedding the metal film as well as the inner surface of the softened through hole into the groove.

3. The method of embedding an insert part as set forth in claim 1, further forming, in advance, a resin layer on the outer circumferential surface of the insert part.

4. The method of embedding an insert part as set forth in claim 1, wherein the resin layer is comprised of a curing reaction type resin.

5. The method of embedding an insert part as set forth in claim 4, wherein the curing reaction type resin is a rapid curing epoxy resin.

6. The method of embedding an insert part as set forth in claim 1, wherein the resin layer is comprised of a soft resin.

7. The method of embedding an insert part as set forth in claim 6, wherein the soft resin is a polyamide resin or urethane resin.

8. The method of embedding an insert part as set forth in claim 1, further forming, in advance, an electroplated layer or dip-immersed solder plated layer on the outer circumferential surface of the insert part.

9. The method of embedding an insert part as set forth in claim 1, wherein the metal film comprises any of the following pairs of materials and film thicknesses:
Ni film: film thickness 3 to 100 μm
Sn alloy film: film thickness 3 to 200 μm
Al alloy film: film thickness 3 to 200 μm
Au film: film thickness 3 to 200 μm
Ag alloy film: film thickness 3 to 200 μm
Cr film: film thickness 3 to 100 μm
C film: film thickness 3 to 400 μm

10. The method of embedding an insert part as set forth in claim 1, wherein the metal film is formed by any of the following:
Electroless plating or electrolytic plating or other wet process
Vacuum deposition
Sputtering
Electron beam

11. The method of embedding an insert part as set forth in claim 1, wherein only one end of the through hole, on the insert side of the insert part, is opened while the other end is closed.

12. A method of embedding an insert part by embedding an insert part comprised of a metal, at the inner side of which a female screw is formed, into a frame comprised of a thermoplastic resin, then further metallizing the entire surface with a metal film, said insert part embedding method comprising:
fastening the insert part inside the frame;
applying a masking member so as to cover the surface of the female screw at the inner side of the insert part which is fastened inside the frame;
metallizing the masking member as well as the entire surface of the frame by the metal film; and
removing the masking member after metallization.

13. The method of embedding an insert part as set forth in claim 12, wherein in said applying of the masking member, the masking member is comprised of a resin male screw which engages with the female screw.

14. The method of embedding an insert part as set forth in claim 12, wherein in said applying of the masking member, the masking member is comprised of a metal male screw that engages with the female screw and the surface of the metal male screw is coated with a resin layer.

15. The method of embedding an insert part as set forth in claim 12, wherein the resin layer is a polyamide resin, polycarbonate resin, fluorine resin, or silicone-based resin.

16. The method of embedding an insert part as set forth in claim 12, wherein in said applying of the masking member, the masking member is comprised of soft silicone rubber, and the soft silicone rubber is pushed into the female screw with a pushing jig.

17. The method of embedding an insert part as set forth in claim 12, wherein in said applying of the masking member, a resin hollow pipe is inserted in the female screw, the hollow pipe is charged with air, and the two ends of the hollow pipe are sealed to obtain the masking member.

18. The method of embedding an insert part as set forth in claim 12, wherein in said applying of the masking member, the masking member is a paste-like printing ink comprised of paraffin screen printed so as to be pushed into the female screw.
